(19) United States
(12) Patent Application Publication
(10) Pub. No.: US 2008/0063936 A1
(43) Pub. Date: Mar. 13, 2008

(54) Portable Battery Power Supply

(76) Inventor: LeRoy C. Hansen, Suamico, WI (US)

Correspondence Address: HARSHAW RESEARCH, INC., 210 W. TECUMSEH STREET, OTTAWA, KS, 66067, US

(21) Appl. No.: 11/768,342

(22) Filed: Jun. 26, 2007

Related U.S. Application Data
(60) Provisional application No. 60/843,418, filed on Sep. 11, 2006.

(51) Int. Cl. H01M 2/08

(52) U.S. Cl. 429/185

(57) ABSTRACT

A portable battery supply includes a liquid impervious housing having a receptacle defining an open top and interior cavity. A top cover is releasably attached to the receptacle for covering the open top, the cover defining an opening. A plurality of batteries are positioned in the interior cavity. A hollow cylindrical member is attached to the top cover and extends a relative distance into the interior cavity, the cylindrical member being accessible through the top cover opening. An auxiliary power receptacle is positioned in the cylindrical member and is electrically connected to the batteries for supplying voltage to electronic devices when plugged into the auxiliary power receptacle. A round power receptacle may be situated in the receptacle and electrically connected to the batteries. An AC/DC adapter connectable to AC power may be electrically connected to a charging unit that is connectable to the round power receptacle for charging the batteries.

### CROSS REFERENCE TO RELATED APPLICATION

This non-provisional patent application claims the benefit of provisional application Ser. No. 60/843,418 filed on Sep. 11, 2006.

### BACKGROUND

This version of the invention is concerned with the field of portable devices that supply electrical power at remote locations. More specifically, this version of the invention is concerned with a rechargeable portable device that delivers electrical power to operate a variety of portable electrical equipment, including radios, GPS locating systems, cell phones, flashlights, and the like in various outdoor and remote backcountry environments.

### PRIOR ART

People who engage in outdoor recreational activities, such as fishing, hiking, hunting, and the like, frequently use a variety of electrically-powered devices to assist them in the pursuit of their activity. These devices typically include but are not limited to radios, cell phones, flashlights, electric knives and other tools, hand-held global positioning systems (GPS), and the like. The power source is usually a low-voltage internal battery that has a power storage capacity of limited duration. When the battery is depleted of power, it can be recharged with use of a plug in AC/DC adapter and charging unit that is plugged into a receptacle providing 120 VAC house power. The plug in AC/DC adapter and charging unit coverts 120 VAC house power to DC power and steps down the voltage to 12 volts.

In outdoor and remote backcountry locations, such electrical devices are usually depleted after a few hours of use, and it is difficult if not impossible to secure the means (i.e., 120 VAC house power) to recharge the internal battery of these devices. What is needed then to overcome the aforementioned disadvantages of limited power capacity of such electrical devices and the difficulty if not impossibility of securing recharge power is the provision of a portable battery power supply able to provide electrical power over an extended duration for continued operation of such electrical devices. The portable battery power supply that is the subject of the instant invention is comprised of an external, liquid impervious housing that contains a series of batteries stored therein, internal wiring and circuitry, a first external power receptacle to receive 120 VAC power to recharge said batteries, and a second external power receptacle to deliver electrical power from the batteries at 12 volts to power the referenced electrical devices and tools.

### DISCUSSION OF THE PRIOR ART

The existence of a portable battery power supply designed to provide electrical power to a variety of electrical devices and tools in outdoor and remote backcountry environments is unknown at the present time. For example, numerous designs for portable power supply devices have been provided in the prior art. Even though these designs may be suitable for the specific individual purposes to which they address, they would not be suitable for the purposes of the present version of the invention as such designs are of limited versatility and power storage capacity or are overly elaborate and cumbersome, making them difficult to transport and use effectively in outdoor and remote backcountry environments. These designs are exemplified by the following patents:
U.S. Pat. No. 3,919,615, Power Belt, issued to Niecke on Nov. 11, 1975;
U.S. Pat. No. 3,963,972, Portable Power Package, Issued to Todd on Jun. 15, 1976;
U.S. Pat. No. 5,387,858, Energy-Conserving Multiple Power Source And Method For Battery-Operated Products, issued to Bender et al. on Feb. 7, 1995;
U.S. Pat. No. 5,686,809, Combination Solar and External Battery Powered Camera Battery Charger, issued to Kimura et al. on Nov. 11, 1997;
U.S. Pat. No. 6,577,098, Apparatus And Method For Providing A Mobile AC Power Supply, issued to Griffey et al. on Jun. 10, 2003;
U.S. Pat. No. 6,774,602, Apparatus And Method For Providing Temporary Power, issued to Ballard et al. on Aug. 10, 2004; and
U.S. Pat. No. 6,894,457, Universal Multiple Device Power Adapter And Carry Case, issued to Germagian et al. on May 17, 2005.

As illustrated by the background art, efforts are continuously being made in an attempt to develop devices for providing electrical devices and tools at outdoor and remote backcountry locations. No prior effort, however, provides the benefits attendant with the present invention.

As such, it may be appreciated that there is a continuing need for a new and improved portable battery power supply that is relatively compact, lightweight, rechargeable and able to provide for extended duration electrical power at 12 volts to various electrically-powered tools and devices. In these respects, the present version of the invention substantially departs from the conventional concepts and designs of the prior art, and in so doing provides and apparatus that substantially fulfills this need. Additionally, the prior patents and commercial techniques do not suggest the present inventive combination of component elements arranged and configured as disclosed herein.

The present invention achieves its intended purposes, objects, and advantages through a new, useful and unobvious combination of method steps and component elements, with the use of a minimum number of functioning parts at a reasonable cost to manufacture, and by employing only readily available materials.

### SUMMARY

The present version of the invention, which will be described in greater detail hereinafter, relates to the field of portable devices that supply electrical power at remote locations. More specifically, this version of the invention is concerned with a rechargeable portable device that delivers electrical power to operate a variety of portable electrical equipment, including radios, GPS locating systems, cell phones, flashlights, and the like in various outdoor and remote backcountry environments. My version of the invention overcomes all of the shortcomings listed previously, in addition to novel aspects that will be described in detail hereinafter.

Described briefly, according to a first embodiment, the invention presents a portable battery power supply to provide electrical power at 12 volts over extended duration to power various electrical devices and tools commonly used in outdoor and remote backcountry environments. The portable battery power supply is comprised of a rectangular, liquid impervious housing that consists of a top cover and a hollow receptacle. The receptacle is comprised first and second opposed shorter lateral sidewalls, first and second opposed longer lateral sidewalls, and a bottom sidewall. The sidewalls enclose a cavity or internal space. Fifteen Nicad batteries rated at 1.2 volts each are located within the cavity of the receptacle. As a group, the batteries produce between 18-20 volts. The batteries are connected to each other at opposing terminals by flat plates.

A first external power receptacle designed to receive 120 VAC house power for recharging the batteries is located in a shorter lateral sidewall. A negative power line is connected at a first end to a negative terminal of the first external power receptacle and at a second end to a flat plate connected to a negative terminal of a battery and then to a 12-volt voltage regulator. The 12-volt voltage regulator steps down power total power of 18-20 volts produced by the batteries to 12 volts. A positive power line is connected at a first end to a positive terminal of the first external power receptacle and at a second end to a flat plate connected to a positive terminal of a battery and then to the 12-volt voltage regulator. Two other power lines connect negative and positive terminals of two batteries to respective positive and negative terminals of two adjacent batteries. A Third power line connects the 12-volt voltage regulator to a second external power receptacle located in the top cover. A flexible, liquid impervious membrane is situated on the top of the batteries under the top cover to prevent liquid, dirt and debris from entering the interior of the hollow receptacle.

The batteries can be recharged to full capacity by connecting a plug in AC/DC adapter and charging unit to a power receptacle providing 120 VAC house power. The plug in delivers 22 VDC to the charging unit. The charging unit, connected to the first external power receptacle, delivers stepped down DC voltage to the receptacle and attached negative and positive wires for recharging the batteries.

The batteries when fully charged deliver electrical power at 12 volts through the 12-volt voltage regulator to the second external power receptacle located in the top cover of the portable battery power supply. During use, the plug or power cord of an electrical device, such as a radio or handheld global positioning system (GPS), can be inserted into the second external power receptacle. The stored charge of the 15 batteries will deliver electric power to the electrically-powered equipment for several hours.

A belt loop is located on the bottom sidewall of the receptacle of the portable battery power supply. The user can insert a belt or strap into the belt loop to carry the portable battery power supply around the waist, upon a backpack, or other article of clothing or gear.

The portable battery power supply in an alternate embodiment contains 19 batteries to produce approximately 23 volts. Fifteen of the batteries are stored within the receptacle as described previously, and four batteries are stored within a hollow protrusion located within the top cover.

My invention, therefore, resides not in any one of these features per se, but rather in the particular combination of all them herein disclosed. It is distinguished from the prior art in this particular combination of all of its structures for the functions specified.

In order that the detailed description of the invention may be better understood and that the present contribution to the invention will be described hereinafter. It should be appreciated by those skilled in the art that the conception and the disclosed specific methods and structures may be readily utilized as a basis for modifying or designing other structures for carrying out the same purposes of the present invention. It should be realized by those skilled in the art that such equivalent methods and structures do not depart from the spirit and scope of the invention.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention.

Further, the purpose of the foregoing abstract is to enable the U.S. Patent and trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application nor is it intended to be limiting as to the scope of the invention in any way.

Accordingly, it is an object of my version of the invention to provide a low-cost, easy-to-manufacture, and easy-to-market portable battery power supply.

A further object of my version of the invention is to provide an easy-to-use and versatile portable battery power supply.

A significant object of the invention is to provide a portable battery power supply that is comprised of a liquid impervious housing, a series of low-voltage batteries stored therein, a first external power receptacle to receive 120 VAC power to recharge said batteries, a second external power receptacle to deliver electrical power from the batteries at 12 volts to electrical devices and tools plugged therein, and internal wiring and circuitry connecting the batteries to the first and second external power receptacles.

A final but very significant object of the invention is to provide a portable battery power supply that provides a low voltage electrical power over an extended duration to allow continued operation of radios, cell phones, flashlights, electric knives and other tools, hand-held global positioning systems (GPS), and the like in various outdoor and remote backcountry environments.

For a better understanding of the invention, its operating advantages and the specific objects attained by its uses, reference should be made to the accompanying drawings and descriptive matter in which there is illustrated a preferred embodiment of the invention. The foregoing has outlined some of the more pertinent objects of the invention. These objects should be construed to be merely illustrative of some of the more prominent features and applications of the present invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiment in addition to the scope of the invention illustrated by the accompanying drawings.

### BRIEF DESCRIPTION OF THE DRAWINGS

The foregoing and other objects, features and advantages of the invention will become more fully understood from the following description of the preferred embodiment of the like reference characters refer to the same parts throughout different views. The drawings are not necessarily to scale, emphasis instead being placed upon illustrating the principles of the invention.

FIG. 1 is an exploded perspective view of a portable power battery supply illustrating the constituent components thereof.

FIG. 2 is a perspective view of an assembled portable power battery supply connected to a plug-in AC/DC adapter and charging unit.

FIG. 3 is a bottom perspective view of a portable power battery supply illustrating a belt loop located thereon.

### DESCRIPTION OF THE PREFERRED EMBODIMENTS

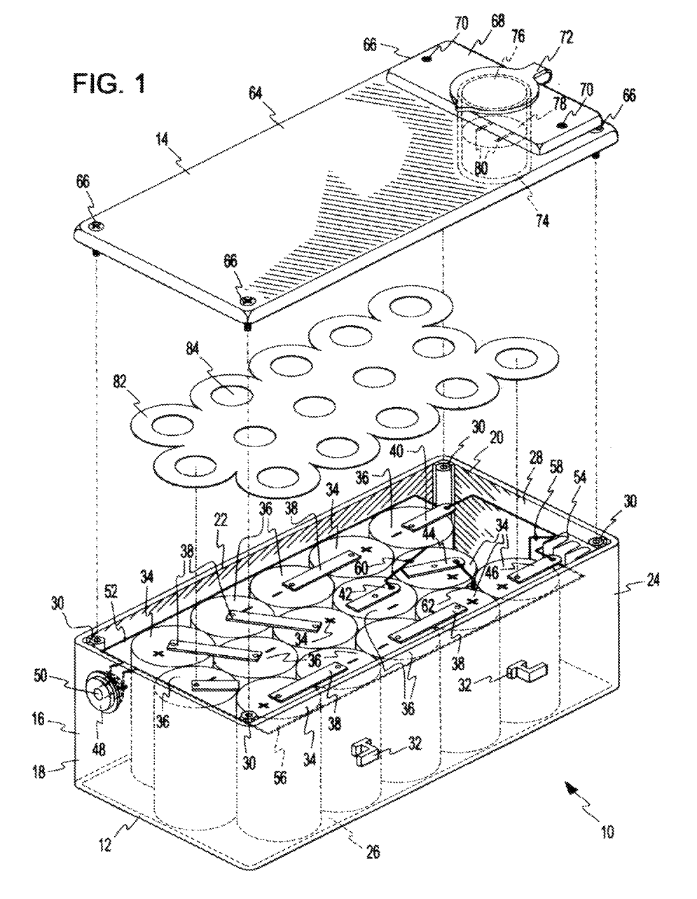

Referring now to the drawings and, in particular, to FIG. 1 wherein there is illustrated a typical embodiment of the portable battery power supply 10. The present version of the invention 10 consists of a rectangular, liquid-impervious housing 12 that is comprised of a top cover 14 and a receptacle 16, said top cover 14 releasably attached to the receptacle 16. The receptacle 16 consists of first 18 and second 20 opposed shorter lateral sidewalls; first 22 and second 24 opposed longer lateral sidewalls; and a bottom sidewall 26 (shown in phantom line). In this application and particularly the claims, the term “receptacle” refers to receptacle 16 so as not to be confused with the “power receptacles” that will be discussed later. The sidewalls 18, 20, 22, 24, 26 enclose an interior cavity 28. Four cylindrical members 30 with central aperture are located in the junction of the shorter lateral sidewalls 18, 20 and longer lateral sidewalls 22, 24. Two hooks 32 are located medially on the exterior side of on longer lateral sidewall 24. The receptacle 16 contains 15 1.2 volt Nicad batteries 34, 36, which produce between 18-20 volts as a group. Seven batteries 34 are situated within the receptacle 16 with the positive terminals facing up, and eight batteries 36 are situated within the receptacle 16 with the negative terminals facing up.

Five flat plates 38 are attached to ten batteries and connect the positive terminal of one battery 34 with the negative terminal of an adjacent battery 36. Four flat plates 40, 42, 44, 46 with rounded ends containing an aperture are attached to four individual batteries 34, 36. A first flat battery 36; a second flat plate 42 is attached to the negative terminal of a second battery 36; a third flat plate 44 is attached to the positive terminal of a third battery 34; and a fourth flat plate 46 is attached to the positive terminal of a fourth battery 34.

A round power receptacle 48 with central aperture 50 is located within the first shorter lateral sidewall 18 of the receptacle 16. A negative wire 52 is attached at a first end thereof to a negative terminal of the round power receptacle 48 and at a second, opposed end to a 12-volt voltage regulator (not shown). The 12-volt voltage regulator is located adjacent to a heat sink 54 that is attached to the inside surface of the second shorter lateral sidewall 20. The 12-volt voltage regulator has a capacity up to 35 volts and is able to reduce the 20 volts produced by the batteries 34, 36 to 12 volts for supplying power to various pieces of electrical equipment and devices, such as radios, cell phones, flashlights, electric knives and other tools, hand-held global positioning systems (GPS), and the like. The negative wire 52 passes through the aperture at the rounded end of the first flat plate 40 attached to the negative terminal of a battery 36.

A positive wire 56 (shown in phantom line) is attached at a first end thereof to a positive terminal of the round power receptacle 48 and at a second, opposed end to the 12-volt voltage regulator. The positive wire 56 passes through the aperture at the rounded end of the fourth flat plate 46 attached to the positive terminal of a battery 34.

A first power supply wire 58 is attached at a first end thereof to the 12-volt voltage regulator and at a second end to a power receptacle, as will be described later in this disclosure. A second power supply wire 60 is attached at a first end thereof to the rounded end of the second flat plate 42 at the negative terminal of a battery 36 and at a second end to the positive terminal of an adjacent battery 36. The negative terminal of the adjacent battery 36 is attached to the first flat plate 40. A third power supply wire 62 is attached at a first end thereof to the rounded end of the third flat plate 44 at the positive terminal of a battery 34 and at a second end to the negative terminal of an adjacent battery 34. The positive terminal of the adjacent battery 34 is attached to the fourth flat plate 46.

The top cover 14 is aligned for releasable attachment to the receptacle 16. The top cover 14 is comprised in part of a first flat rectangular panel 64 having a perimeter identical to that of the receptacle 16. Threaded fasteners 66 are located within the four corners of the first flat panel 64 and are aligned for insertion into the apertures of the cylindrical members 30 of the receptacle 16. A second flat panel 68 is attached at one end of the first flat panel 64. The second flat panel 68 along the longitudinal axis thereof is oriented in perpendicular relation to the longitudinal axis of the first flat panel 64. The second flat panel 68 is secured to the first flat panel of the top cover 14 by threaded fasteners 70. A cover 72 is flexibly attached to the second flat panel 68.

A hollow cylindrical member 74 (shown in phantom line) is attached centrally to the second flat panel 68 and extends for some distance below the first 64 and second 68 flat panels. The cylindrical member 74 encloses a cavity 76 (shown in phantom line) and an auxiliary power receptacle 78 (shown in phantom line) below the cavity 76. The auxiliary power receptacle 78 contains two narrow apertures 80. The power line 58 is connected to the bottom of the receptacle 78 to deliver power stored by the batteries 34, 36 to the receptacle 78.

A flexible, liquid impervious membrane 82 with apertures 84 is aligned above the batteries 34, 36. When the cover 14 is attached to the receptacle 16, the membrane 82 rests upon the top ends of the batteries 34, 36 to prevent liquid, dirt, and other debris from entering the cavity 28 of the receptacle 16. The membrane 82 also performs this protective function when the cover 14 is detached from the receptacle 16.

The cover 14 and receptacle 16 are manufactured of material that is lightweight, durable, rigid, electrically non-conductive, and impervious to transmission of liquid and gases, such as high-impact plastic, fiberglass various composite materials, and the like. The membrane 82 is manufactured of material that is lightweight, durable, flexible, electrically non-conductive, and impervious to transmission of liquid and gases, such as rubber, soft plastic, various composite materials, and the like. The portable battery power supply 10 when assembled is 6.25 inches long, 3 inches wide, and 2.125 inches high. Total weight is approximately 1 pound, 10.5 ounces.

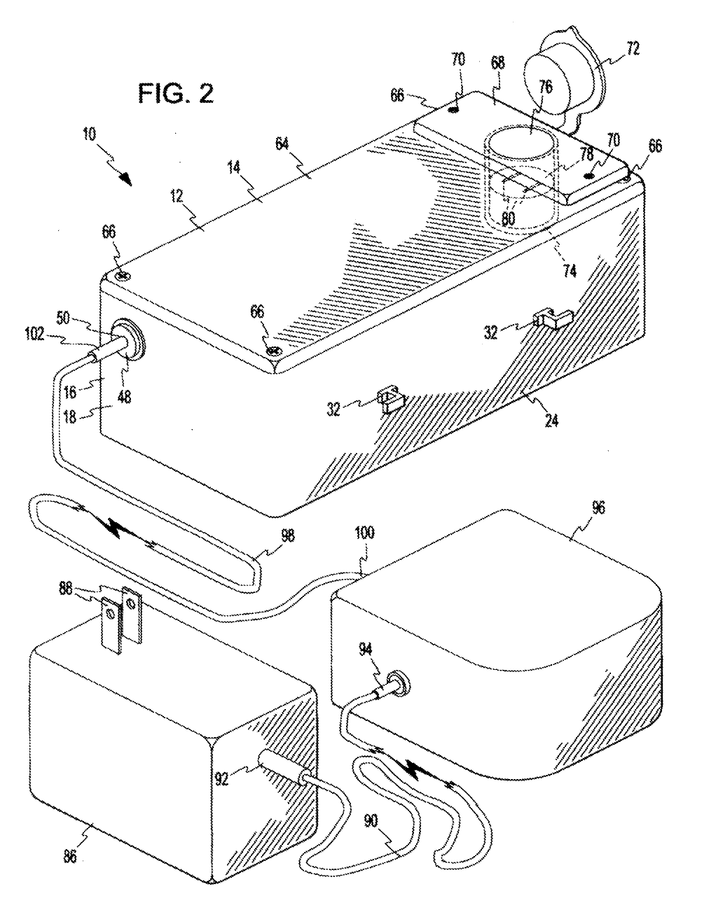

Referring to FIG. 2, therein illustrated is the portable battery power supply 10 fully assembled with the cover 72 separated from and raised above the second flat panel 68. With the cover 72 raised as such, access is provided to the cavity 76 and auxiliary receptacle 78 therewithin.

A plug in AC/DC adapter 86 with receptacle prongs 88 is attached to a first power wire 90. More particularly, the power wire 90 at a first end 92 thereof is attached to the plug in AC/DC adapter 86. The power wire 90 as a second end 94 thereof is attached to a charging unit 96. A second power wire 98 is attached at a first end thereof 100 to the charging unit 96 and at a second end 102 thereof to the round power receptacle 48. The plug in AC/DC adapter 86 receives normal house power at 120 VAC, 60 Hz, coverts it to 22 VDC, and delivers 22 VDC over the first power line 90 to the charging unit 96. The charging unit 96 delivers stepped down DC voltage over the second power line 98 to the round power receptacle 48 and attached negative 52 and positive 56 wires for recharging the batteries 34, 36.

During use, the plug or power cord of an electrical device, such as a VHF radio or hand-held global positioning system (GPS), can be inserted into the cavity 76 and power receptacle 78 located below the first 64 and second 68 panels of the top cover 14. The stored charge of the 15 1.2 volt Nicad batteries 34, 36 (18-20 volts stepped down to 12 volts) will deliver electric power to the electrical equipment for several hours. The power cord of the electrical device can be wrapped around the hooks 32 during transport of the portable battery power supply 10 and electrical device attached thereto.

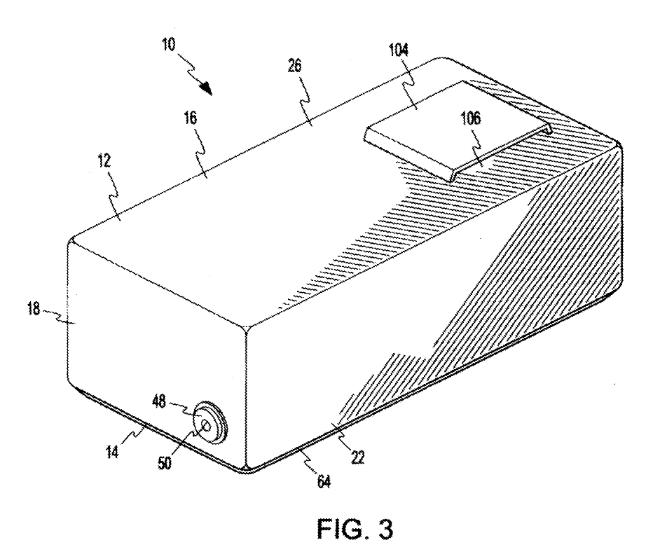

As shown in FIG. 3, a belt loop 104 is formed onto, attached to, or otherwise located on the bottom sidewall 26 of the receptacle 16 of the portable battery power supply 10. The belt loop 104 and an adjacent portion of the bottom sidewall 26 create a slot 106 into which a belt can be inserted. In this manner, the user of the portable battery power supply 10 can carry the device 10 around the waist, upon a backpack, or other article of clothing or gear onto which a belt may be strapped, connected, attached or wrapped around.

In an alternate embodiment of the invention 10, 19 1.2 volt Nicad batteries 34, 36 are stored therein to produce approximately 23 volts. Fifteen of the batteries 34, 36 are stored within the receptacle 16 as described previously, and four batteries 34, 36 are stored in two rows of two batteries 34, 36 within a hollow protrusion located within the first panel 64 of the top cover 14.

While this version of the invention has been illustrated and described in detail in the drawings and foregoing description, the same is to be considered as illustrative and not restrictive in character, it being understood that only the preferred embodiment has been shown and described and that all changes and modifications that come within the spirit of the version of the invention are desired to be protected. With that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

### CONCLUSION AND SCOPE OF INVENTION

From the foregoing, it will be understood by persons skilled in the art that an improved portable battery power supply has been provided. The invention is relatively simple and easy to manufacture, yet affords a variety of uses. While my description contains many specificities, these should not be construed as limitations on the scope of the version of the invention, but rather an exemplification of the preferred illustrative only the principles of the invention. Further since numerous modifications and changes will readily occur to those skilled in the art, it is not to limit the invention to the exact construction and operation shown and described, and accordingly all suitable modifications and equivalents may be resorted to, falling within the scope of the invention. Although this invention has been described in its preferred form with a certain degree of particularity, it is understood that the present disclosure of the preferred form has been made only by way of example and numerous changes in the details of construction and combination and arrangement of parts may be resorted to without departing from the spirit and scope of the invention.

1. A portable battery supply, comprising:
a housing constructed of a liquid impervious material, said housing including a receptacle defining an open top and an interior cavity;
a top cover releasably attached to said receptacle for covering said open top;
a plurality of batteries positioned in said interior cavity of said receptacle, a predetermined number of said plurality of batteries being positioned with respective positive terminals facing up and another predetermined number of said plurality of batteries being positioned with respective negative terminals facing up;
a first and second plurality of flat plates connected to said respective positive and negative terminals for accessing voltage from said plurality of batteries;
a round power receptacle defining a central aperture situated within said receptacle and electrically connected to said first and second plurality of flat plates; and
an AC/DC adapter connectable to AC power and electrically connected to a charging unit that is selectively connectable to said power receptacle for charging said plurality of batteries.

2. The portable battery supply as in claim 1, further comprising:
a hollow cylindrical member connected to said top cover and extending into said interior cavity of said receptacle, said top cover defining an opening for accessing said cylindrical member; and
an auxiliary power receptacle positioned in said cylindrical member and electrically connected to said plurality of batteries, whereby electronic devices may be powered by said plurality of batteries when electrically connected to said auxiliary power receptacle.

3. The portable battery supply as in claim 2 further comprising a cover flexibly attached to said top cover for selectively covering said opening defined by said top cover.

4. The portable battery supply as in claim 1 wherein said impervious material is lightweight, durable, electrically non-conductive, and selected from a group consisting of high impact plastic or fiberglass.

5. The portable battery supply as in claim 1 further comprising an impervious membrane positioned in said interior cavity of said receptacle and sandwiched between said plurality of batteries and said top cover for preventing liquid, dirt, and debris from entering said interior cavity.

6. The portable battery supply as in claim 5 wherein said impervious membrane defines a plurality of apertures, each aperture being positioned to register with a respective terminal end of each of said plurality of batteries.

7. The portable battery supply as in claim 5 wherein said impervious membrane is constructed of a material selected from the group consisting of rubber, plastic, or composite material.

8. The portable battery supply as in claim 1 further comprising a pair of spaced apart hooks located on an exterior sidewall of said housing about which an electrical cord may be wrapped for storage or transport.

9. The portable battery supply as in claim 1 further comprising a belt loop attached to a sidewall of said receptacle such that said housing may be coupled to a belt of a user.

10. A portable battery supply, comprising:
a housing constructed of a liquid impervious material, said housing including a receptacle defining an open top and an interior cavity;
a top cover releasably attached to said receptacle for selectively covering said open top, said top cover defining an opening;
a plurality of batteries positioned in said interior cavity of said receptacle;
a hollow cylindrical member attached to said top cover and extending a relative distance into said interior cavity, said cylindrical member being accessible through said top cover opening;
an auxiliary power receptacle positioned in said cylindrical member and electrically connected to said plurality of batteries for supplying voltage to electronic devices when plugged into said auxiliary power receptacle.

11. The portable battery supply as in claim 10, further comprising a cover flexibly attached to said top member for selectively covering said top cover opening.

12. The portable battery supply as in claim 10 further comprising:
a round power receptacle defining a central aperture situated within said receptacle and electrically connected to said plurality of batteries; and
an AC/DC adapter connectable to AC power and electrically connected to a charging unit that is selectively connectable to said round power receptacle for charging said plurality of batteries.

13. The portable battery supply as in claim 10, wherein said impervious material is lightweight, durable, electrically non-conductive, and selected from a group consisting of high impact plastic or fiberglass.

14. The portable battery supply as in claim 12 further comprising an impervious membrane positioned in said interior cavity of said receptacle and sandwiched between said plurality of batteries and said top cover for preventing liquid, dirt, and debris from entering said interior cavity.

15. The portable battery supply as in claim 10 further comprising an impervious membrane positioned in said interior cavity of said receptacle and sandwiched between said plurality of batteries and said top cover for preventing liquid, dirt, and debris from entering said interior cavity.

16. The portable battery supply as in claim 10, wherein said impervious membrane defines a plurality of apertures, each aperture being positioned to register with a respective terminal end of each of said plurality of batteries.

17. The portable battery supply as in claim 15 wherein said impervious membrane is constructed of a material selected from the group consisting of rubber, plastic, or composite material.

18. The portable battery supply as in claim 10 further comprising a pair of spaced apart hooks located on an exterior sidewall of said housing about which an electrical cord may be wrapped for storage or transport.

19. The portable battery supply as in claim 10 further comprising a belt loop attached to a sidewall of said receptacle such that said housing may be coupled to a belt of a user.

20. A portable battery supply, comprising:
a housing constructed of a liquid impervious material, said housing including a receptacle defining an open top and an interior cavity;
a top cover releasably attached to said receptacle for selectively covering said open top, said top cover defining an opening;
a plurality of batteries positioned in said interior cavity of said receptacle;
a hollow cylindrical member attached to said top cover and extending a relative distance into said interior cavity, said cylindrical member being accessible through said top cover opening;
an auxiliary power receptacle positioned in said cylindrical member and electrically connected to said plurality of batteries for supplying voltage to electronic devices when plugged into said auxiliary power receptacle;
a round power receptacle defining a central aperture situated within said receptacle and electrically connected to said plurality of batteries; and
an AC/DC adapter connectable to AC power and electrically connected to a charging unit that is selectively connectable to said round power receptacle for charging said plurality of batteries;
an impervious membrane positioned in said interior cavity of said receptacle and sandwiched between said plurality of batteries and said top cover for preventing liquid, dirt, and debris from entering said interior cavity, said impervious membrane being constructed of a material selected from the group consisting of rubber, plastic, or composite material;
wherein said impervious membrane defines a plurality of apertures, each aperture being positioned to register with a respective terminal end of each of said plurality of batteries;
a pair of spaced apart hooks located on an exterior sidewall of said housing about which an electrical cord may be wrapped for storage or transport.
